(19) United States
(12) Patent Application Publication
(10) Pub. No.: US 2026/0203955 A1
(43) Pub. Date: Jul. 16, 2026

(54) AI-BASED VIDEO CONFERENCING USING ROBUST FACE RESTORATION WITH ADAPTIVE QUALITY CONTROL

(71) Applicant: INTERDIGITAL VC HOLDING, INC., Wilmington, DE (US)

(72) Inventors: Wei JIANG, Sunnyvale, CA (US); Hyomin CHOI, Sunnyvale, CA (US); Fabien RACAPE, San Francisco, CA (US)

(21) Appl. No.: 19/134,246

(22) PCT Filed: Nov. 30, 2023
(86) PCT No.: PCT/US2023/081843

§ 371 Date: May 30, 2025

Related U.S. Application Data
(60) Provisional application No. 63/429,574, filed on Dec. 2, 2022.

(51) Int. Cl. G06T 9/00; H04N 19/154

(52) U.S. Cl. CPC G06T 9/002; H04N 19/154

(57) ABSTRACT

A video conferencing framework based on face restoration uses information such as pose and expressions instead of using information from different source frames and driving frames. In an embodiment, this information comes from the current target frame. In another embodiment, the proposed system uses a discrete codebook-based representation comprising a generic branch that generates and transmits an integer vector indicating the indices of codewords, from which the decoder retrieves a rich high-quality codebook-based feature based on the same shared codebook with an encoder. An adaptive branch optionally provides additional detailed fidelity and expressive features using a low-quality low-bitrate downsized face input and further aggressively compressed. The low-quality feature is weighted and combined with the high-quality feature for final reconstruction. In another embodiment, an online adaptive learning mechanism adjusts the low-quality input and the combining weight for the adaptive branch on the encoder side at test time.

### CROSS REFERENCE TO RELATED APPLICATION

This application claims the benefit of U.S. Application Ser. No. 63/429,574, filed Dec. 2, 2022, which is incorporated by reference herein in its entirety.

### TECHNICAL FIELD

At least one of the present embodiments generally relates to a method or an apparatus for compression and decompression of images and videos for video conferencing with human-centric video content.

### BACKGROUND

Recent years have witnessed the meteoric rise of video conferencing, which has become a daily communication mean at work and in life. By and large, standard video codecs such as AVC (which has been widely being used for such video conferencing applications), HEVC and VVC have been developed for compressing natural image/video data. In recent years, end-to-end Learned Image Coding (LIC) or video coding based on Neural Networks (NN) have also been developed.

### SUMMARY

At least one of the present embodiments generally relates to a method or an apparatus in the context of a video conferencing framework based on face restoration. Instead of using information from different source and driving frames, information such as pose, expression, identity, appearance, and texture, for example, comes from the current target frame, which avoids the instability of the previous video conferencing solutions based on face reenactment. To provide similar ultra-low bitrates, the proposed system uses a discrete codebook-based representation.

According to a first aspect, there is provided a method. The method comprises steps for determining at least one embedded feature of a video image; obtaining a codebook-based representation of the at least one embedded feature based on a codebook; resampling the video image to obtain a low-quality resampled video image; compressing the low-quality resampled video image to obtain a low-quality latent representation; and, transmitting the codebook-based representation, the low-quality latent representation, and a combining weight.

According to a second aspect, there is provided a method. The method comprises steps receiving a codebook-based representation, a low-quality latent representation of a video image, and a combining weight; retrieving a codeword corresponding to the codebook-based representation to form a decoded embedding feature; decoding the low-quality latent representation; computing a low-quality embedding feature based on the decoded low-quality input; and, reconstructing the video image based on the decoded embedding feature, the low-quality embedding feature, and the combining weight.

According to another aspect, there is provided an apparatus. The apparatus comprises a processor. The processor can be configured to implement the general aspects by executing any of the described methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

According to another general aspect of at least one embodiment, there is provided a non-transitory computer readable medium containing data content comprising instructions to perform any of the encoding or decoding methods.

### BRIEF DESCRIPTION OF THE DRAWINGS

FIG. 1 illustrates an example of general workflow of AI-based video conferencing system.

FIG. 2 illustrates a preferred embodiment of the workflow of the proposed AI-based encoding module.

FIG. 3 illustrates a preferred embodiment of the workflow of the proposed AI-based decoding module.

FIG. 4 illustrates a preferred embodiment of the workflow of the proposed online adaptive learning by tuning both the low quality and the combining weights.

FIG. 5 illustrates a preferred embodiment of the workflow of the proposed online adaptive learning by the combining weights only.

FIG. 6 illustrates an exemplary result of an original and reconstructed face image.

FIG. 7 illustrates an exemplary application using the proposed approach for video conferencing scenario: (a) less bits and less reality but visually pleasing (b) moderate bit transmission and some extent close to real face (c) real face details at highest bits

FIG. 8 illustrates one embodiment of a method for encoding video using the described embodiments.

FIG. 9 illustrates one embodiment of a method for decoding video using the described embodiments.

FIG. 10 illustrates one embodiment of an apparatus for encoding or decoding using the described embodiments.

FIG. 11 illustrates a standard, generic video compression scheme.

FIG. 12 illustrates a standard, generic video decompression scheme.

FIG. 13 illustrates a processor-based system for encoding/decoding under the general described aspects.

### DETAILED DESCRIPTION

The video coding tools in prior video codecs are designed to improve coding efficiency for general image and video content, some specially designed for screen contents. They are not optimized for the video conferencing scenario.

In most cases, human faces become the primary content of video conferencing, e.g., one or multiple people talking at the center of the video frame. Since facial attributes are widely shared between people from the structural perspective, such characteristics can be efficiently coded with common representations that cost much less bits to transfer than compressing original pixels with off-the-shelf codecs. This enables a coding framework to compress the face with extremely low bitrate and to reconstruct the face with decent quality. Recently, NVIDIA's Maxine solution used the face reenactment algorithm for the video conferencing scenario. Briefly, one High-Quality (HQ) source frame along with a facial keypoint representation are coded and transferred to the decoder such that successive video frames are synthesized at the receiver. To reduce severe artifacts in practice, the enhancement algorithm in a prior approach has been studied by using multiple source images and only reenacting segmented face pixels.

The prior arts of the face reenactment-based methods are innately unstable due to the large discrepancy between the source frame and the target frame in real applications. The keypoint representation of faces is highly compact to transfer but carries only pose and expression information, which cannot provide rich details for high-quality face generation. Transferring identity and appearance from the source frame to the target frame is inevitably prone to artifacts, especially with non-negligible change of lighting, poses, expressions, etc. Using multiple source frames may alleviate the problem, yet with the price of maintaining a large pool of source frames and performing multiple reenactment processes in decoder.

For general video conferencing, given a set of input video frames I₁ . . . , I_{N}, an Encoder generates a compressed representation Lᵢ for each video frame Iᵢ, which consumes less bits than the original input video frame Iᵢ to send to a Decoder. The Decoder recovers an output video frame Îᵢ based on the received compressed representation Lᵢ, and the previously received L₁ . . . , Lᵢ₋₁. The goal is to minimize both distortion D(Iᵢ, Îᵢ) (e.g., MSE or SSIM) and bitrate R(Lᵢ).

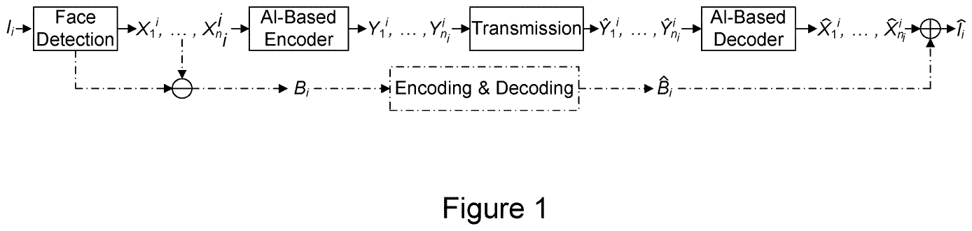

FIG. 1 shows an example of a general AI-based video conferencing workflow. Each input frame Iᵢ is fed into a Face Detection module and human faces

$${X}_{1}^{i} , … , {X}_{{n}_{i}}^{i}$$

are detected. Each face

$${X}_{j}^{i}$$

is a cropped region in Iᵢ defined by a bounding box containing the detected human face in the center with some extended areas. For example, the region is centered at the center of the detected face and the width and height of the bounding box are a times and b times of the width and height of the face respectively (a≥1, b≥1). This approach does not put any restrictions on the face detection method or how to crop the bounding box of the face region. Also, one can decide to only consider some detected faces (e.g., the largest faces or the faces in the center of the video frame). This approach does not put restrictions on how many faces or what faces to consider either.

Let Bᵢ denote the remaining background pixels in frame Iᵢ that are not included in any of the human faces one decides to consider. There can be different ways for the video conferencing system to process Bᵢ. For example, an optional Encoding & Decoding module can aggressively compress Bᵢ by traditional HEVC/VVC, or LIC or video coding, which is then transmitted to the decoder where a decoded \hat{B}ᵢ can be obtained. In some cases, Bᵢ can be simply discarded, e.g., when a predefined virtual background is used. How to process the background pixels Bᵢ is out of the scope of this approach. Therefore, the optional processing flows for Bᵢ are marked by dotted lines.

For each face

$${X}^{i} , j = 1 , … , {n}_{i}$$

to consider, on the encoder side, an AI-Based Encoder computes a corresponding latent representation

$${Y}_{j}^{i} , j = 1 , … , {n}_{i} ,$$

which usually consumes less bits to transfer by a Transmission module, which also computes a recovered latent representation

$${\hat{{Y}_{j}}}^{i} , j = 1 , … , {n}_{i}$$

on the decoder side. Usually, the latent representation

$${Y}_{j}^{i}$$

is further compressed in the Transmission module before transmission, e.g., by lossless arithmetic coding, and a corresponding decoding process is needed to recover

$${\hat{{Y}_{j}}}^{i}$$

in the Transmission module. This approach does not put any restrictions on the potential further compression and decoding methods of the latent representation. Based on the recovered latent representation all

$${\hat{{Y}_{j}}}^{i} , j = 1 , … , {n}_{i} ,$$

an AI-Based Decoder reconstructs the output face

$${\hat{X}}_{j}^{i} , j = 1 , … , {n}_{i} .$$

In the case where a decoded background \hat{B}ᵢ is provided, the output face

$${\hat{X}}_{j}^{i} , j = 1 , … , {n}_{i}$$

is merged back with \hat{B}ᵢ to generate the final reconstructed frame Îᵢ. This approach does not put any restriction on how to merge

$${\hat{X}}_{j}^{i} , j = 1 , … , {n}_{i}$$

with \hat{B}ᵢ.

Prior video conferencing solutions are based on the idea of face reenactment, which transfers the facial motion of one driving face image to another source face image. Given the video frames I₁ . . . , I_{N}, faces

$${X}_{j}^{i} , j = 1 , … , {n}_{i} , i = 1 , … ,$$

M in the first M (1≤M<N) frames are transmitted to the Decoder with high bitrates to ensure the quality of the decoded faces, by using traditional HEVC/VVC, or LIC or video coding methods. These faces are called source features, which carry the appearance and texture information of the person in the conferencing session. For example, M=1 in one prior method and M>1 in another approach. Then faces in the remaining frames

$${X}_{j}^{l} , j = 1 , … , {n}_{l} , l = M + 1 , … ,$$

N are called driving faces. Facial landmark keypoints such as on left and right eyes, nose, brows, lip, etc. are extracted from both source frames and driving frames, which carry the pose and expression information of the person. Usually some additional information, such as the 3D head pose, is also computed from both the source and the driving frames. Then for face

$${X}_{j}^{l}$$

in the driving frame Iₗ, using a corresponding face

$${X}_{j}^{i}$$

in the source frame Iᵢ, based on the computed 3D head pose and landmark keypoints, a transformation function can be learned to transfer the pose and expression of the driving face

$${X}_{j}^{l}$$

to the source face

$${X}_{j}^{i} ,$$

and a reenactment neural network is used to generate the output reenacted face

$${X}_{j}^{li} .$$

Then multiple reenacted faces

$${X}_{j}^{l i} , i = 1 , … ,$$

M using multiple source faces are combined by interpolation to obtain the final output face

$${\hat{X}}_{j}^{l} .$$

The prior solution presents severe flaws when applied to realistic faces in the wild. First, due to the difficulty in generating real hair, teeth, accessories, etc., which cannot be described by the facial keypoints, artifacts are often inevitable. By only applying the reenactment process to the tightly cropped or segmented face region, the artifacts can be reduced but not eliminated, with additional computation and transmission overhead. In addition, prior solutions are innately unstable, because the reenacted face relies on the appearance and texture information from the source frame and the pose and expression information from another driving frame. The performance suffers from large discrepancy between the source and target faces caused by changes of illuminations, pose, expressions, etc. By maintaining a large pool of candidate source frames and select only the ones most similar to the current target driving frame, the problem can be alleviated but not eliminated, with the price of largely increased decoding complexity where one needs to maintain a large pool of source frames and needs to perform the reenactment process many times in decoder.

The described embodiments propose a novel video conferencing framework based on face restoration. Instead of using information from different source and driving frames, all information (pose, expression, identity, appearance and texture) comes from the current target frame, which avoids the instability of the previous video conferencing solutions based on face reenactment. To provide similar ultra-low bitrates, the proposed system uses a discrete codebook-based representation. The key idea is to combine the power of generic face prior learning with data-dependent detail recovery to achieve robust HQ face restoration with very low bitrates (e.g., PSNR of 33 dB with only 0.03 bpp). The data-dependent detail recovery also avoids the difficulty encountered by facial keypoint-based generation for hair, teeth, accessories, etc.

The proposed framework comprises of two branches. The generic branch generates and transmits an integer vector indicating the indices of codewords, from which the decoder retrieves a rich HQ codebook-based feature based on the same shared codebook with the encoder. A baseline HQ face can be robustly restored using the HQ codebook-based feature. The adaptive branch optionally provides additional detailed fidelity and expressive feature using a Low-Quality (LQ) low-bitrate face input resized from input and further aggressively compressed by LIC. The LQ feature is weighted combined with the HQ feature for final reconstruction, which provides flexibility to balance bitrate and restoration quality. For ultra-low bitrate, the system relies more on HQ feature to ensure an HQ face with less detail by assigning a lower weight to the LQ feature. With higher bitrate, a better LQ feature can be obtained and a larger weight gives more detail and fidelity. We will describe the resizing from a downsampling perspective, but any resizing including upsampling can apply to any of the embodiments.

In addition, the described embodiments further propose an online adaptive learning mechanism to adjust the LQ input and the combining weight for the adaptive branch on the encoder side at test time. Since video conferencing is a learning task with Ground-Truth (GT) target in the test stage, adjusting the network input and combining weight online enables effective adaptation through direct Stochastic Gradient Decent (SGD) for better reconstruction tuned to each particular data, without any overhead in transmission or decoding computation.

### Proposed Baseline Solution

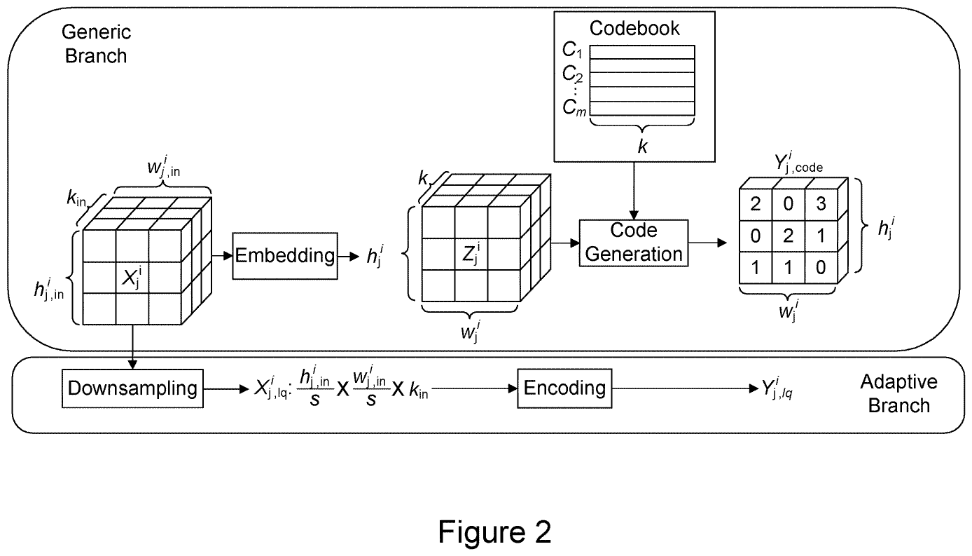

FIG. 2 shows an embodiment of the workflow of the AI-based Encoder. First, in the Generic Branch, the system is given the input frame

$${X}_{j}^{i}$$

of size

$${h}_{j , in}^{i} \times {w}_{j , in}^{i} \times {k}_{i n}$$

where

$${h}_{j , in}^{i} , {w}_{j , in}^{i}$$

and kᵢₙ are the height, width, and the number of channels, respectively. For example, kᵢₙ=3 for RGB color image, kᵢₙ=1 for grey image, kᵢₙ=4 for RGB+Depth image, etc. An Embedding module computes an embedded feature

$${Z}_{j}^{i}$$

of size

$${h}_{j}^{i} \times {w}_{j}^{i} \times k .$$

The embedding module typically is a Neural Network (NN) consisting of several computational layers such as convolution, (non-)linear activation, normalization, attention, skip connection, resizing, etc. The height

$${h}_{j}^{i}$$

and width

$${w}_{j}^{i}$$

of the embedded feature

$${Z}_{j}^{i}$$

depends on the size of input image as well as the network structure of the Embedding module, and the number of feature channels k depends on the network structure of the Embedding module. The encoder is provided with a learnable codebook [symbol] ={c₁, . . . , cₘ} containing m codewords. Each codeword cₗ is represented as a k dimensional feature vector. Then a Code Generation module computes a codebook-based representation

$${Y}_{j , c o d e}^{i}$$

based on the embedded feature

$${Z}_{j}^{i}$$

and the codebook [symbol] . Specifically, each element

$${z}_{j}^{i} ( u , v )$$

in

$${Z}_{j}^{i} ( u = 1 , … , {h}_{j}^{i} , v = 1 , … , {w}_{j}^{i} )$$

is also a k dimensional feature vector, which is mapped to an optimal codeword c_{idx(u,v)}(u, v) closest to

$${z}_{j}^{i} ( u , v ) :$$

$$i d x ( u , v ) = arg {min}_{l = 1}^{m} D ( {z}_{j}^{t} ( u , v ) , {c}_{l} ) , \qquad ( 1 )$$

where

$$D ( {z}_{j}^{i} ( u , v ) , {c}_{l} )$$

is the distance between

$${z}_{j}^{i} ( u , v )$$

and cₗ (e.g., L₂ distance). That is,

$${z}_{j}^{i} ( u , v )$$

can be approximated by the codeword index idx(u, v), and the embedded feature

$${Z}_{j}^{i}$$

can be represented by the approximate integer codebook-based representation

$${Y}_{j , code}^{i}$$

comprising

$${h}_{j}^{i} \times {w}_{j}^{i}$$

codeword indices. This integer codebook-based representation

$${Y}_{j , code}^{i}$$

consumes very few bits compared to the original input

$${X}_{j}^{i}$$

to transfer.

In the Adaptive Branch, the input

$${X}_{j}^{i}$$

is downsampled by a scale of s (e.g., 4 times along both height and width) in a Downsampling module to obtain a low-quality

$${X}_{j , lq}^{i}$$

of size

$$\frac{{h}_{j , in}^{i}}{s} \times \frac{{w}_{j , in}^{i}}{s} \times {k}_{in} .$$

For example, a bicubic/bilinear filter can be used to perform downsampling, and this approach does not put any constraint on the downsampling method. Then the low-quality

$${X}_{j , lq}^{i}$$

is aggressively compressed by an Encoding module to compute a low-quality latent representation

$${Y}_{j , lq}^{i}$$

for transmission. The Encoding module can use various methods to compress the low-quality

$${X}_{j , lq}^{i} .$$

For example, an NN-based LIC method can be used. Also, a traditional video coding tool like H.265/H.266 can also be used. In the preferred embodiment, the compression rate is high so that the low-quality latent representation

$${Y}_{j , lq}^{i}$$

consumes little bits. Inis approach does not put any restrictions on the specific method or the compression settings of the method used to compress the low-quality

$${X}_{j , lq}^{i} .$$

Finally, the codebook-based representation

$${Y}_{j , code}^{i}$$

and the low-quality latent representation

$${Y}_{j , lq}^{i}$$

together from the latent representation

$${Y}_{j}^{i}$$

in FIG. 1, which is transmitted to the decoder. At the same time, a combining weight

$${W}_{j}^{i}$$

is also sent to the decoder, which will be used to guide the decoding process.

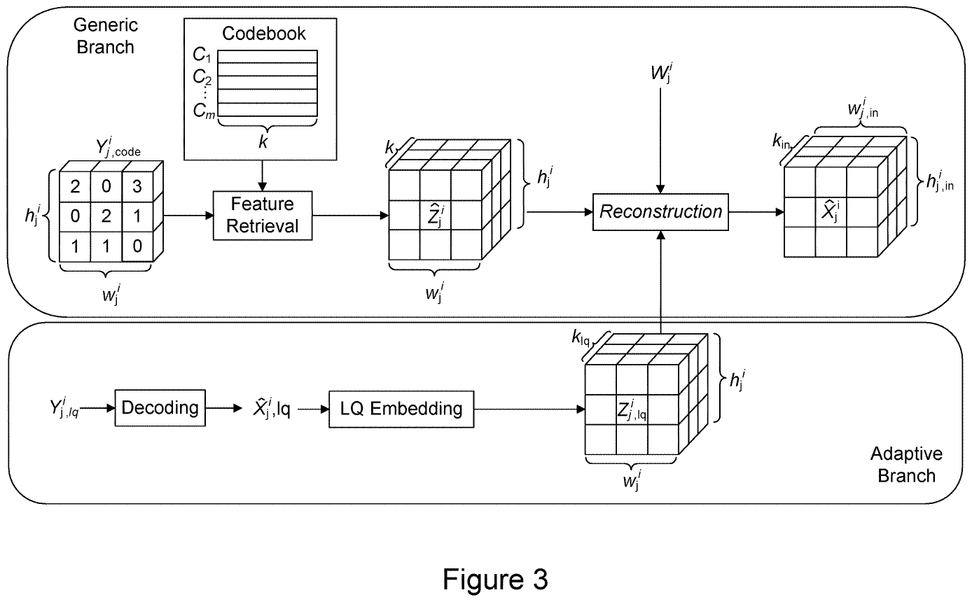

FIG. 3 shows an embodiment of the workflow of the AI-based Decoder. First, in the generic branch, after receiving the codebook-based representation

$${Y}_{j , code}^{i} ,$$

a Feature Retrieval module retrieves the corresponding codeword c_{idx(u,v)}(u, v) for each index idx(u, v) to form the decoded embedding feature

$${\hat{Z}}_{j}^{i}$$

of size

$${h}_{j}^{i} \times {w}_{j}^{i} \times k ,$$

based on the same codebook [symbol] ={c₁, . . . , cₘ} as in the encoder. In the adaptive branch, after receiving the low-quality latent representation

$${Y}_{j , lq}^{i} ,$$

a Decoding module decodes a decoded low-quality input

$${\hat{X}}_{j , lq}^{i}$$

using a decoding method corresponding to the encoding method used in the Encoding module. For example, an NN-based LIC method can be used. Also, any conventional image or video codecs such as HEVC, WC, etc., can be used. Then an LQ Embedding module computes a low-quality embedding feature

$${Z}_{j , lq}^{i}$$

of size

$${h}_{j}^{i} \times {w}_{j}^{i} \times {k}_{l q}$$

based on the decoded low-quality input

$${\hat{X}}_{j , lq}^{i} .$$

The LQ Embedding network is similar to the Embedding module in the encoder, which typically is an NN including layers like convolution, non-linear activation, normalization, attention, skip connection, resizing, etc. This approach does not put any restrictions on the network architectures of the LQ Embedding module.

Given the decoded embedding feature

$${\hat{Z}}_{i}^{i}$$

and the low-quality embedding feature

$${Z}_{j , lq}^{i} ,$$

as well as the combining weight

$${W}_{j}^{i}$$

received from the encoder, a Reconstruction module computes the reconstructed output

$${\hat{X}}_{j}^{i} .$$

The Reconstruction module can consist of several computational layers such as convolution, (non-)linear activation, normalization, attention, skip connection, resizing, etc. There are multiple ways to combine the decoded embedding feature

$${\hat{Z}}_{j}^{i}$$

and the low-quality embedding feature

$${Z}_{j , lq}^{i}$$

too (e.g., through concatenation, modulation, etc.). The combining weight

$${W}_{j}^{i}$$

determines how important the low-quality embedding feature

$${Z}_{j , lq}^{i}$$

is when combined with

$${\hat{Z}}_{j}^{i} .$$

This approach does not put any restrictions on the network architectures of the Reconstruction module or the way to combine

$${Z}_{j , lq}^{i} and {\hat{Z}}_{j}^{i} .$$

The combining weight

$${W}_{j}^{i}$$

is sent from the encoder to the decoder. The encoder can determine the combining weight

$${W}_{j}^{i}$$

in many ways. For example, in one embodiment, the best performing

$${W}_{j}^{i}$$

can be selected from a set of preset weights based on a target performance metric (e.g., the Rate-Distortion tradeoff). The

$${W}_{j}^{i}$$

can be selected for each video frame individually, or the system can determine

$${W}_{j}^{i}$$

based on part of the video frames (e.g., the first frames of the video conferencing session) based on the averaged performance metric of these frames, and then fix the selected weights for the rest frames.

### Proposed Online Solution

In a preferred embodiment of the approach, an online adaptive learning mechanism is further proposed to automatically determine the combining weights

$${W}_{j}^{i}$$

and provides additional flexibility for improving the video conferencing performance according to the target needs on the fly. The proposed online adaptive learning mechanism tunes the combining weights

$${W}_{j}^{i}$$

and optionally the low-quality

$${X}_{j , lq}^{i}$$

during the inference process according to a target online loss. The online adaptive learning

$${W}_{j}^{i}$$

to the decoder. The decoding process stays the same as in FIG. 1 and FIG. 3, since the determination of the combining weights

$${W}_{j}^{i}$$

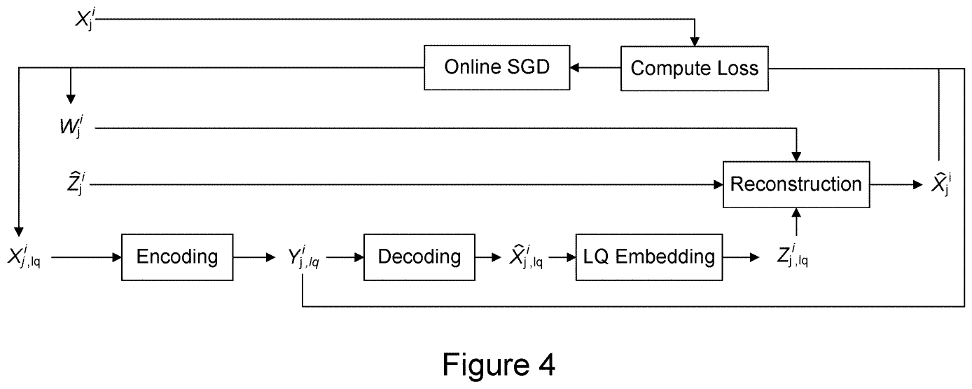

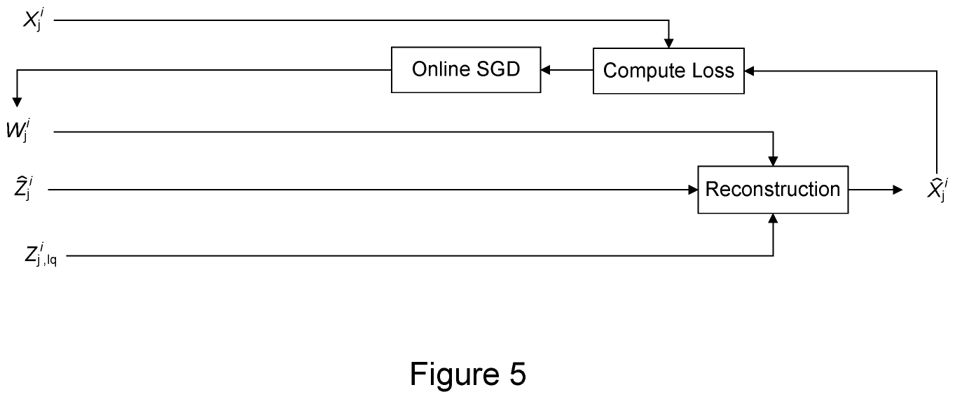

in the encoder does not change the processing pipeline in decoder. FIGS. 4 and 5 give two preferred embodiments of the workflow of the online adaptive learning, where FIG. 4 tunes both the combing weights

$${W}_{j}^{i}$$

and the low-quality

$${X}_{j , lq}^{i} ,$$

and FIG. 5 only tunes the combining weights

$${W}_{j}^{i} .$$

Specifically, during online adaptive learning, the system first performs the encoding and decoding process described by FIG. 1, FIG. 2 and FIG. 3, based on the input

$${X}_{j}^{i}$$

and the initial combining weight

$${W}_{j}^{i} ,$$

to obtain the decoded embedding feature

$${\hat{Z}}_{j}^{i} ,$$

the low-quality

$${X}_{j , lq}^{i} ,$$

the low-quality latent representation

$${Y}_{j , l q}^{i} ,$$

and the reconstructed output

$${\hat{X}}_{j}^{i} .$$

The system keeps the decoded embedding feature

$${\hat{Z}}_{j}^{i}$$

unchanged. Then a Compute Loss module computes an online loss

$$L ( {X}_{j}^{i} , {\hat{X}}_{j}^{i} , {Y}_{j , lq}^{i} )$$

based on the reconstructed output

$${\hat{X}}_{j}^{i} ,$$

the original input

$${X}_{j}^{i} ,$$

and the low-quality latent representation

$${Y}_{j , l q}^{i} .$$

For example, the Rate-Distortion tradeoff loss can be used:

$$L ( {X}_{j}^{i} , {\hat{X}}_{j}^{i} , {Y}_{j , lq}^{i} ) = D ( {X}_{j}^{i} , {\hat{X}}_{j}^{i} ) + λ R ( {Y}_{j , lq}^{i} ) \qquad ( 2 )$$

Where

$$D ( {X}_{j}^{i} , {\hat{X}}_{j}^{i} )$$

measures the distortion between

$${\hat{X}}_{j}^{i} and {X}_{j}^{i}$$

(e.g., the MSE, SSIM, the perceptual loss like LIPIPS, or a weighted combination of these losses).

$$R ( {Y}_{j , l q}^{i} )$$

is the rate loss measuring the bit consumption of the low-quality latent representation

$${Y}_{j , lq}^{i}$$

(e.g., the entropy likelihood estimated by the first prior method). This loss is differentiable and an Online SGD module computes the gradient

$$\frac{\partial L ( {X}_{j}^{i} , {\hat{X}}_{j}^{i} , {Y}_{j , lq}^{i} )}{\partial {W}_{j}^{i}}$$

of the online loss

$$L ( {X}_{j}^{i} , {\hat{X}}_{j}^{i} , {Y}_{j , lq}^{i} )$$

against the weights

$${W}_{j}^{i}$$

and the gradient ∂L(Xⱼⁱ, \hat{X}ⱼⁱ, Y_{j,lq}ⁱ/∂X_{j,lq}^{l} of the online loss

$$L ( {X}_{j}^{i} , {\hat{X}}_{j}^{i} , {Y}_{j , lq}^{i} )$$

against the low-quality

$${X}_{j , lq}^{i} ,$$

which are backpropagated to update the combining weights and the low-quality

$${X}_{j , lq}^{i} :$$

$${W}_{j}^{i} ( t ) = {W}_{j}^{i} ( t - 1 ) - α \frac{\partial L ( {X}_{j}^{i} , {\hat{X}}_{j}^{i} , {Y}_{j , lq}^{i} )}{\partial {W}_{j}^{i}}$$

$${X}_{j , lq}^{i} ( t ) = {X}_{j , lq}^{i} ( t - 1 ) - β \frac{\partial L ( {X}_{j}^{i} , {\hat{X}}_{j}^{i} , {Y}_{j , lq}^{i} )}{\partial {X}_{j , lq}^{i}}$$

Where t is the index of the current iteration, and t=1, . . . , T if T iterations are taken in total. α and β are step sizes for online adaptation, which can be empirically preset as hyperparameters, or determined on the fly by searching through a few different settings, similar to the initial combining weight

$${W}_{j}^{i} ( 0 ) .$$

This approach does not put any restrictions on how to set the hyperparameters.

Finally, after T iterations of online updates, the updated

$${X}_{j , lq}^{i} ( t )$$

is used to recompute the low-quality latent representation

$${Y}_{j , lq}^{i} ,$$

which is sent to the decoder together with the updated

$${W}_{j}^{i} ( T )$$

and the codebook-based representation

$${Y}_{j , code}^{i}$$

### in FIG. 2.

Note that to make the online loss differentiable against the low-quality input

$${X}_{j , lq}^{i}$$

so that the gradient

$$\frac{\partial L ( {X}_{j}^{i} , {\hat{X}}_{j}^{i} {Y}_{j , lq}^{i} )}{\partial {X}_{j , lq}^{i}}$$

can be computed, the method used by the Encoding and Decoding modules for compressing the low-quality input

$${X}_{j , lq}^{i}$$

in FIG. 2 and FIG. 3 is an NN-based LIC method. In comparison, FIG. 5 describes the preferred online adaptive learning workflow where only the combining weights

$${W}_{j}^{i}$$

are tuned. In this scenario, the Encoding and Decoding module can use non-differentiable traditional video codecs such as HEVC/VVC.

Similar to the case in FIG. 4, during online adaptive learning, the system in FIG. 5 first performs the encoding and decoding process as presented in FIG. 1, FIG. 2 and FIG. 3, based on the input

$${X}_{j}^{i}$$

and the initial combining weight

$${W}_{j}^{i} ,$$

to obtain the decoded embedding feature

$${\hat{Z}}_{j}^{i} ,$$

the low-quality embedding feature

$${Z}_{j , lq}^{i} ,$$

and the reconstructed output

$${\hat{X}}_{j}^{i} .$$

The system keeps decoded embedding feature Žⱼⁱ and the low-quality embedding feature

$${Z}_{j , lq}^{i}$$

unchanged. Then a Compute Loss module computes an online loss

$$L ( {X}_{j}^{i} , {\hat{X}}_{j}^{i} )$$

based on the reconstructed output

$${\hat{X}}_{j}^{i}$$

and the original input

$${X}_{j}^{i} .$$

For example,

$$L ( {X}_{j}^{i} , {\hat{X}}_{j}^{i} )$$

measure the distortion between

$${\hat{X}}_{j}^{i} and {X}_{j}^{i}$$

(e.g., the MSE, SSIM, the perceptual loss like LIPIPS, or a weighted combination of these losses). This loss is differentiable and an Online SGD module computes the gradient

$$\frac{\partial L ( {X}_{j}^{i} , {\hat{X}}_{j}^{i} )}{\partial {W}_{j}^{i}}$$

of the online loss

$$L ( {X}_{j}^{i} , {\hat{X}}_{j}^{i} )$$

against the weights

$${W}_{j}^{i} ,$$

which is backpropagated to update the combining weights:

$${W}_{j}^{i} ( t ) = {W}_{j}^{i} ( t - 1 ) - α \frac{\partial L ( {X}_{j}^{i} , {\hat{X}}_{j}^{i} )}{\partial {W}_{j}^{i}}$$

Where t is the index of the current iteration, and t=1, . . . , T if T iterations are taken in total. α is the step size for online adaptation, which can be empirically preset as hyperparameters, or determined on the fly by searching through a few different settings, similar to the initial combining weight

$${W}_{j}^{i} ( 0 ) .$$

This approach does not put any restrictions on how to set the hyperparameters.

Finally, after T iterations of online updates, in FIG. 5, the updated the updated

$${W}_{j}^{i} ( T )$$

is sent to the decoder together with the low-quality latent representation

$${Y}_{j , lq}^{i}$$

and the codebook-based representation

$${Y}_{j , code}^{i}$$

described in FIG. 2.

It is worth mentioning that in some embodiments, the entire adaptive branch can be optionally skipped, where the combining weights

$${W}_{j}^{i}$$

is set as

$${W}_{j}^{i} = 0 ,$$

and the Reconstruction module simply reconstructs the output

$${\hat{X}}_{j}^{i}$$

based on the decoded embedding feature

$${\hat{Z}}_{j}^{i} .$$

### Example Training Process

A training process learns the learnable codebook [symbol] ={c₁, . . . , cₘ}, the Embedding network parameters, and the Reconstruction network parameters. Also, when the Encoding module and the Decoding module use NN-based LIC, or the Downsampling module uses a NN-based method, the corresponding network parameters are also learned in the training process. In the preferred embodiment, the different network modules are train in several different stages. For example, in the first stage, the learnable codebook [symbol] ={c₁, . . . , cₘ}, the Embedding network parameters, and the Reconstruction network parameters from the generic branch are trained in an end-to-end fashion by using high-quality face inputs

$${X}_{j}^{i} ,$$

where the training target is to minimize the reconstruction distortion between the reconstructed output

$${\hat{X}}_{j}^{i}$$

and the input

$${X}_{j}^{i} .$$

Various distortion loss can be used, such as MSE, MSSSIM, perceptual LIPIPS, etc., or a weighted combination of different losses. The Generative Adversarial Network (GAN) training strategy can be used to improve the learned codebook quality for visually pleasing reconstruction.

Then in the second stage, the Encoding and Decoding module in the adaptive branch are trained in an end-to-end fashion by, e.g., first using a general image dataset with various image qualities and then finetuning the learned parameters using low-quality face images. The training target is to minimize the Rate-Distortion tradeoff loss of the reconstructed output

$${\hat{X}}_{j}^{i}$$

and the rate loss of the latent representation

$${Y}_{j , lq}^{i}$$

similar to Equation (2). The training method described in the first prior approach can be used here.

Then in the third stage, the LQ Embedding module is trained and the Reconstruction module is finetuned by using a set of training data similar to the real video conferencing test data, in an end-to-end fashion, where all other learned network parameters and the learned codebook are fixed.

In other embodiments, other training strategies can be taken. For example, other training stages can be used where in each stage different modules can be trained or finetuned based on different sets of losses. Or, the entire network can be trained end-to-end in one stage. This approach does not put any restrictions on the training process.

Some Differences from Prior Approaches
a Video Conferencing Solution Based on Robust Face Restoration with Ultra-Low Bitrate and Superior Visual Quality
The proposed pipeline of combining a generic branch and an adaptive branch for effective video conferencing based on face restoration is new. The generic branch ensures baseline high-quality face reconstruction using the highly efficient discrete codebook-based representation. The adaptive branch provides additional details of fidelity and expressiveness by transmitting a low-quality low-bitrate face image.

### Flexible Quality Control for Video Conferencing

The proposed solution enables the feature of flexible quality control for video conferencing. The HQ feature from the generic branch and the LQ feature from the adaptive branch are weighted combined where the combining weight can be tuned at test time to balance bitrate and reconstruction quality. The combining weight can be manually set or automatically set.

### Flexible Online Adaptive Quality Control for Video Conferencing

The proposed solution provides the mechanism of automatically adjusting the LQ face image and the corresponding combining weight for each video frame based on actual needs. This enables the feature of flexible online adaptive quality control where users can adjust the LQ face image and the combining weights according to different quality metrics and different bitrate and quality tradeoffs.

### Advantages Over Prior Approaches

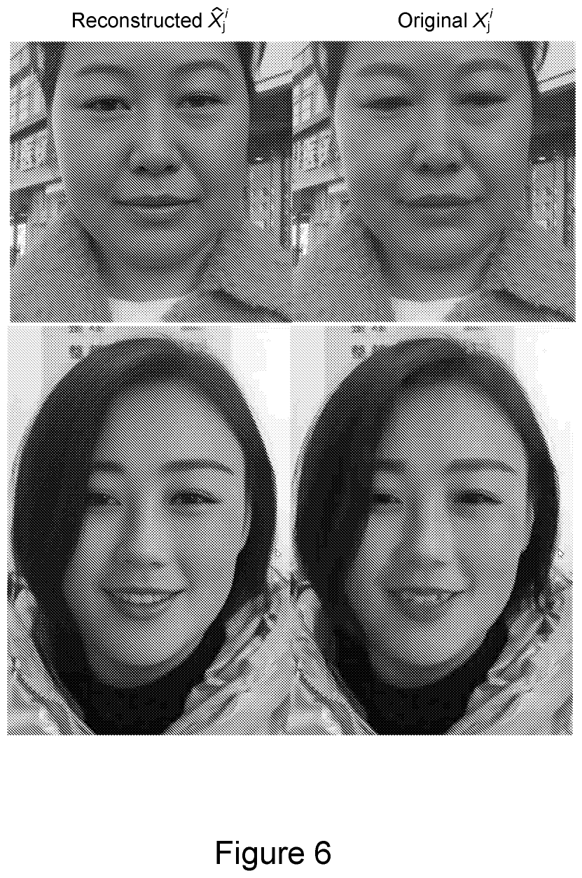

Because the learned high-quality codebook contains learned high-quality face priors, the reconstructed face can be even more visually pleasing than the original input. An example is shown in FIG. 6.
The flexibility of quality control to accommodate various needs at the test time.
Deliver robust and HQ video conferencing experience comparing with prior AI-based video conferencing solutions based on face reenactment.
A flexible framework of adopting various network architectures for individual network module components.
The flexibility to accommodate various Encoding/Decoding methods in the adaptive branch, including both NN-based or traditional codecs

Video conferencing has become a main tool for people's daily communication at work and in life. The application is essentially important to all companies involving in cloud services and end devices, like Apple, Amazon, Google, Tencent, Alibaba, OPPO, Huawei, Zoom, Microsoft, Nvidia, etc.

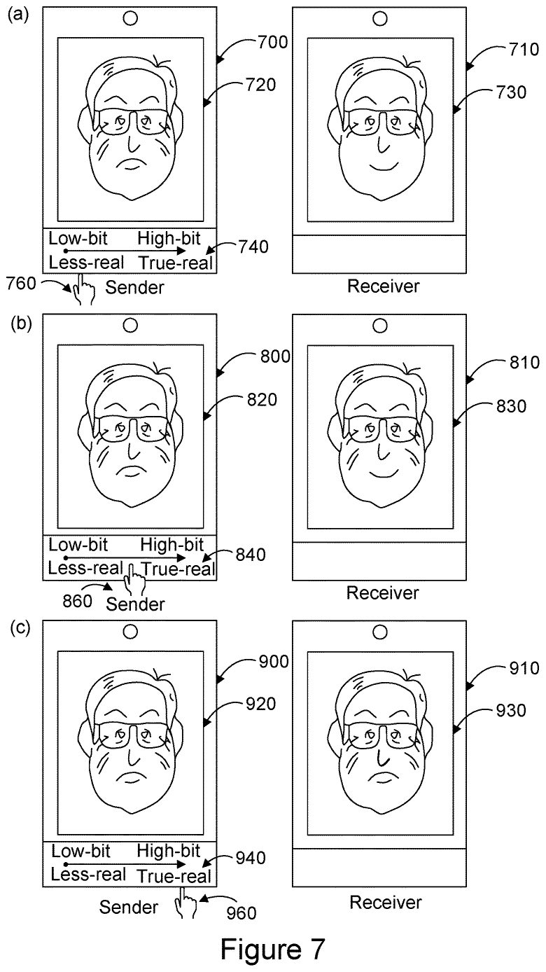

An exemplary application with various scenarios is shown in FIG. 7. A device (700) captures a face region and compresses it using our approach. Captured real input image can be shown in the sender's display device (720). Any type of quality controllable interface (740) can control over some extent of bits to be used to code face or some extent of reality of to-be-delivered face at the receiver device (710). Quality controlling mechanism can vary, but as a simple example, a user (760) can control over the quality of to-be-displayed face at the receiver's display device (730) using human-interface panel (740) on the device (700). The less realistic the face, the fewer bits needed when using the proposed compression method. FIG. 7(a) shows the case when selecting the option for less realistic but lower number of bits to code the face. In this scenario, the generic branch can only be in active to code the face region by mapping the embedded feature to optimized codewords. Then, at the receiver (710), a generic branch decoder re-maps the codes words to embedded features and generates reenacted face. In this case, the reenacted face can be visually more pleasurable but less faithful to the true input face since the transferred information does not deliver any details of the face texture. Therefore, overall face expression of the synthesized face can be dependent on the training dataset used to build the codewords.

FIG. 7(b) presents the scenario when the user choosing the medium reality with medium bits to transfer (860). In this case, some real face texture can deliver to the receiver device (810) by activating the proposed adaptive branch. On top of the least information to present face via generic branch, the proposed adaptive branch further compresses missing details in a lower resolution. Depending on the downsampling ratio or quantization level to code compressed representation of the input, the quality of reenacted face at the receiver side can vary.

Lastly, in FIG. 7(c), when the user choose the highest reality (960), the reconstructed face at the receiver side (910) looks close to the real face compared with the previous scenario. To make the face more real, the proposed adaptive branch compresses the input with lower quantization step size so that details of face texture are reconstructed after the decoding.

The proposed solution includes both encoder and decoder, and it enables novel features that are not achievable by prior arts. The detectability is obvious. The bitstream also requires the relevant syntax information to enable the proposed adaptive quality control.

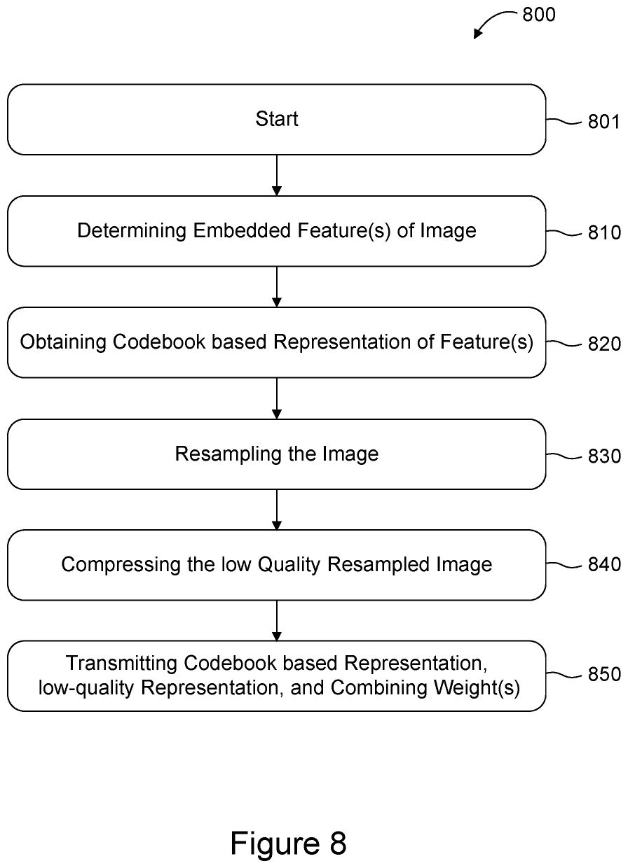

One embodiment of a method 800 for encoding/decoding video data is shown in FIG. 8. The method commences at Start bock 801 and proceeds to block 810 for determining at least one embedded feature of a video image. Control proceeds from block 810 to block 820 for determining obtaining a codebook-based representation of the at least one embedded feature based on a codebook. Control proceeds from block 820 to block 830 for resampling the video image to obtain a low-quality resampled video image. Control proceeds from block 830 to block 840 for compressing the low-quality resampled video image to obtain a low-quality latent representation. Control proceeds from block 840 to block 850 for transmitting the codebook-based representation, the low-quality latent representation, and a combining weight.

Any mention of resampling in this description comprises downsampling, upsampling or no change in the sampling.

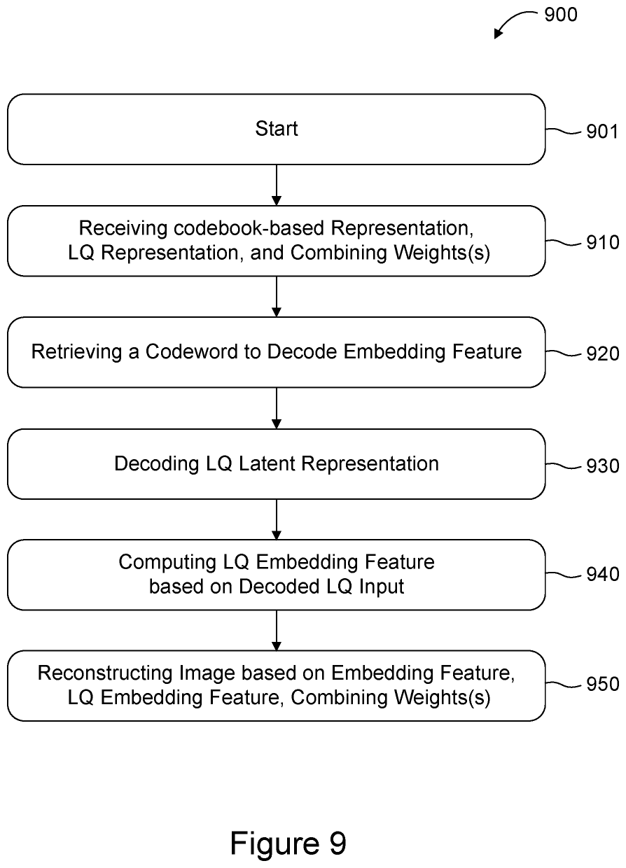

One embodiment of a method 900 for decoding video data is shown in FIG. 9. The method commences at Start block 901 and proceeds to block 910 for receiving a codebook-based representation, a low-quality latent representation of a video image, and a combining weight. Control proceeds from block 910 to block 920 for retrieving a codeword corresponding to the codebook-based representation to form a decoded embedding feature. Control proceeds from block 920 to block 930 for decoding the low-quality latent representation. Control proceeds from block 930 to block 940 for computing a low-quality embedding feature based on the decoded low-quality input. Control proceeds from block 940 to block 950 for reconstructing the video image based on the decoded embedding feature, the low-quality embedding feature, and the combining weight.

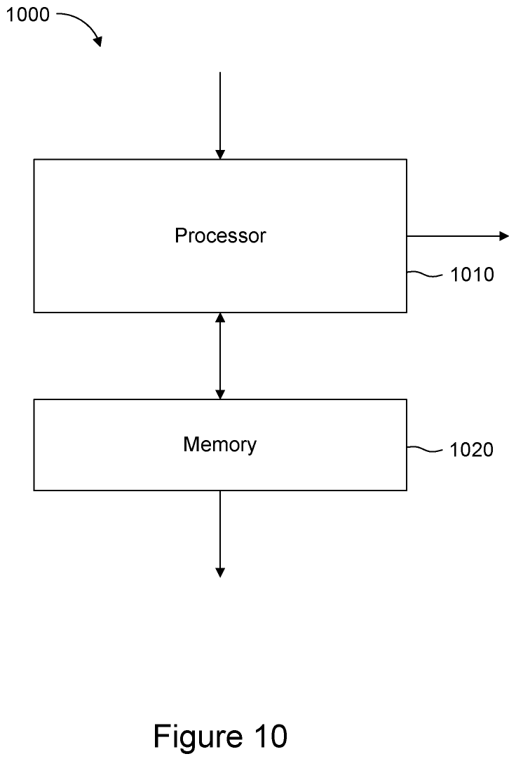

FIG. 10 shows one embodiment of an apparatus 1000 for compressing, encoding or decoding video using the aforementioned methods. The apparatus comprises Processor 1010 and can be interconnected to a memory 1020 through at least one port. Both Processor 1010 and memory 1020 can also have one or more additional interconnections to external connections.

Processor 1010 is also configured to either insert or receive information in a bitstream and, either compressing, encoding, or decoding using the aforementioned methods.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

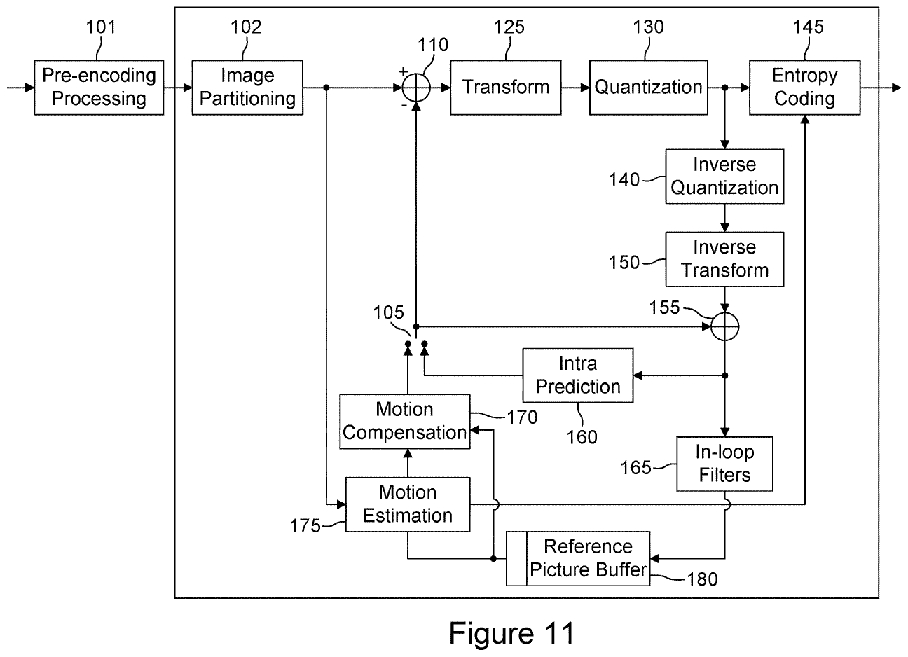

The aspects described and contemplated in this application can be implemented in many different forms. FIGS. 11, 12, and 13 provide some embodiments, but other embodiments are contemplated and the discussion of FIGS. 11, 12, and 13 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” or “reconstructed” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

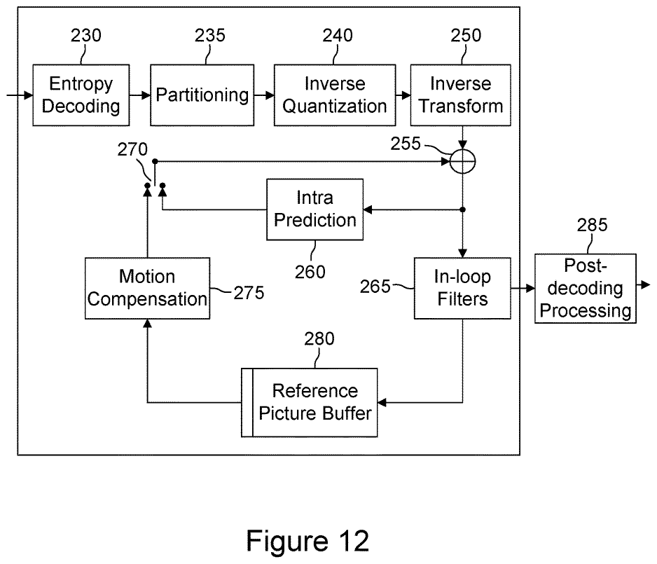

Various methods and other aspects described in this application can be used to modify modules, for example, the intra prediction, entropy coding, and/or decoding modules (160, 360, 145, 330), of a video encoder 100 and decoder 200 as shown in FIG. 11 and FIG. 12. Moreover, the present aspects are not limited to WC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 11 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 12 illustrates a block diagram of a video decoder 200. In the decoder 200, a bitstream is decoded by the decoder elements as described below. Video decoder 200 generally performs a decoding pass reciprocal to the encoding pass as described in FIG. 11. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

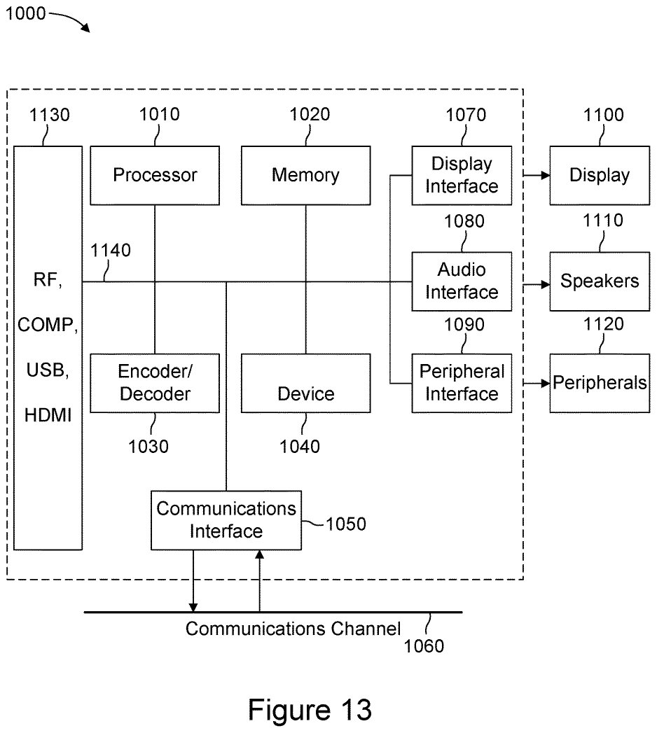

FIG. 13 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 13, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface lcs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

We describe a number of embodiments, across various claim categories and types. Features of these embodiments can be provided alone or in any combination. Further, embodiments can include one or more of the following features, devices, or aspects, alone or in any combination, across various claim categories and types, including a first device comprising user equipment and a second device comprising a network.

A video conferencing framework based on face restoration wherein all information comes from a current target frame.

In one embodiment there is an adaptive online learning mechanism that adjusts a low-quality input and/or the combining weight used to combine the low-quality and high-quality portions.

The present disclosure contemplates creating and/or transmitting and/or receiving and/or decoding a bitstream or signal that includes one or more of the described syntax elements, or variations thereof.

In one embodiment, a TV, set-top box, cell phone, tablet, or other electronic device performs transform method(s) according to any of the embodiments described.

In one embodiment, a TV, set-top box, cell phone, tablet, or other electronic device performs transform method(s) determined according to any of the embodiments described, and displays (e.g., using a monitor, screen, or other type of display) a resulting image.

In one embodiment, a TV, set-top box, cell phone, tablet, or other electronic device selects, bandlimits, or tunes (e.g., using a tuner) a channel to receive a signal including an encoded image, and performs transform method(s) according to any of the embodiments described.

In one embodiment, a TV, set-top box, cell phone, tablet, or other electronic device receives (e.g., using an antenna) a signal over the air that includes an encoded image, and performs transform method(s).

1. A method, comprising:
determining at least one embedded feature of a video image;
obtaining a codebook-based representation of the at least one embedded feature based on a codebook;
resampling the video image to obtain a low-quality resampled video image;
compressing the low-quality resampled video image to obtain a low-quality latent representation; and,
transmitting the codebook-based representation, the low-quality latent representation, and a combining weight.

2. An apparatus, comprising:
memory, and
a processor, configured to perform:
determining at least one embedded feature of a video image;
obtaining a codebook-based representation of the at least one embedded feature based on a codebook;
resampling the video image to obtain a low-quality resampled video image;
compressing the low-quality resampled video image to obtain a low-quality latent representation; and,
transmitting the codebook-based representation, the low-quality latent representation, and a combining weight.

3. A method, comprising:
receiving a codebook-based representation, a low-quality latent representation of a video image, and a combining weight;
retrieving a codeword corresponding to the codebook-based representation to form a decoded embedding feature;
decoding the low-quality latent representation;
computing a low-quality embedding feature based on the decoded low-quality input; and,
reconstructing the video image based on the decoded embedding feature, the low-quality embedding feature, and the combining weight.

4. An apparatus, comprising:
memory, and
a processor, configured to perform:
receiving a codebook-based representation, a low-quality latent representation of a video image, and a combining weight;
retrieving a codeword corresponding to the codebook-based representation to form a decoded embedding feature;
decoding the low-quality latent representation;
computing a low-quality embedding feature based on the decoded low-quality input; and,
reconstructing the video image based on the decoded embedding feature, the low-quality embedding feature, and the combining weight.

5. The method of claim 1, wherein the combining weight is tuned during an inference process.

6. The method of claim 1, wherein the low-quality latent representation is tuned during an inference process.

7. The method of claim 1, wherein the combining weight and low-quality latent representation are updated by back propagating a gradient of online loss against the combining weight.

8. The apparatus of claim 2, wherein updates of a low-quality input are used to recompute the low-quality latent representation and sent to a decoder.

9. The apparatus of claim 2, wherein a step size used for online adaptation is set by hyperparameters or determined on the fly.

10. The apparatus of claim 2, wherein the combining weights are determined from a set of preset weights.

11. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of a video block.

12. A non-transitory computer readable medium containing data content generated according to the method of claim 1, for playback using a processor.

13. (canceled)

14. A computer program product comprising instructions which, when the program is executed by a computer, cause the computer to carry out the method of claim 3.

15. A non-transitory computer readable medium containing data content comprising instructions to perform the method of claim 1.

16. The method of claim 3, wherein the combining weight is tuned during an inference process.

17. The method of claim 3, wherein the low-quality latent representation is tuned during an inference process.

18. The method of claim 3, wherein the combining weight and low-quality latent representation are updated by back propagating a gradient of online loss against the combining weight.

19. The method of claim 1, wherein updated of a low-quality input are used to recompute the low-quality latent representation and sent to a decoder.

20. The method of claim 4, wherein a step size used for online adaption is set by hyperparameters or determined on the fly.

21. The method of claim 3, wherein the combining weights are determined from a set of preset weights.
